(19) United States
(12) Patent Application Publication
(10) Pub. No.: US 2007/0094669 A1
(43) Pub. Date: Apr. 26, 2007

(54) Shared resource acquisition

(75) Inventors: John Austin Rector, Seattle, WA (US); Arun U. Kishan, Bellevue, WA (US); Neill M. Clift, Kirkland, WA (US); Adrian Marinescu, Issaquah, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/257,649

(22) Filed: Oct. 25, 2005

(51) Int. Cl. G06F 9/46

(52) U.S. Cl. 718/104

(57) ABSTRACT

A technology for exclusively acquiring a shared resource is disclosed. In one method approach, the method determines that a shared resource is available to be exclusively acquired by a first thread. The method also prevents partial execution of operations by a second thread, during operations to exclusively acquire the shared resource by the first thread, which may be accomplished by using an interrupt. The preventing of partial execution of operations by the second thread may be initiated by the first thread. The method embodiment then performs operations to exclusively acquire the shared resource by the first thread.

### BACKGROUND

In many computing environments, resources are often shared between various entities. For example, in some computing environments, a common memory space may be accessed by numerous threads of different processes. In such an example, the common memory space can be considered a resource that is shared by the numerous threads. In fact, in computing environments such as symmetric multi-processing (SMP) environments, the shared resource, e.g. a common memory space, may be shared by two or more different processors.

When a resource is shared, access to the shared resource must be intelligently managed to ensure the integrity of the shared resource and its contents. As an example, consider a scenario where the shared resource is a database entry reflecting a bank account balance, and access to the shared resource is not being intelligently managed. If a first thread is attempting to modify the database entry, and a second thread is concurrently attempting to read the database entry, it is possible that the second thread could read an incorrect bank account balance. That is, the second thread could read the database entry at a time when the modification by the first thread was partially completed.

To intelligently manage shared resources, various locking mechanisms are employed. Specifically, shared locks and exclusive locks are commonly used to control access to shared resources. A shared lock allows multiple entities (e.g. threads) to access a shared resource concurrently. When a shared resource is accessed/acquired using a shared lock, the acquiring threads are not allowed to modify the shared resource. That is, read operations are allowed, but modifications such as, for example, INSERT, UPDATE, and DELETE statements are not allowed. In an exclusive lock, only a single entity (e.g. a single thread) is allowed to access the shared resource at a given time. Hence, exclusive locks are often employed when modifying a shared resource.

Due to their differing functionality and applicability, shared and exclusive locks are typically used in combination to manage access to a shared resource. When managing access to a shared resource, it may be desirable to allow alternate ownership of the shared resource between shared and exclusive acquires. That is, it may be necessary to ensure that numerous shared acquisitions of the shared resource do not block or prevent at least occasional exclusive acquisition of the shared resource. Although shared acquisitions of the shared resource can be limited or controlled by, for example, having per-processor memory for shared acquisitions of the shared resource, such an approach is not always desirable. Specifically, such an approach typically requires memory-ordering instructions (e.g. atomic instructions or memory barriers) that are substantially more expensive than regular (i.e. non-atomic) instructions. The expense incurred during acquisition of a shared resource is typically measured in terms of, for example, central processing unit (CPU) workload, time, or memory requirements. Hence, an approach that imposes too much expense by virtue of either shared acquisitions or exclusive acquisitions is not generally feasible.

Single instruction increment and decrement operations are commonly used to manage access to a shared resource. More specifically, a thread count tally is employed in which a thread's count is either incremented or decremented depending upon the operation being performed. The thread count is a logical representation of actions taken by a thread. Typically, as a thread attempts to acquire a shared resource, the count for the acquiring thread is incremented by one. When a thread releases a shared lock or acquisition, the thread's count is decremented by one. Hence, by observing the count of a thread it is possible to determine, to some extent, the past actions taken by the thread. It should be understood that a processor can decode even single-instruction increment and decrement operations into micro-operations (micro-ops) and that such micro-ops can result in race conditions. A single increment instruction may be decoded into, for example three micro-ops of read, increment, and write. Similarly, a single decrement instruction may be decoded into, for example three micro-ops of read, decrement, and write. Consider the following example. A first thread seeking to acquire a shared lock on a shared resource reads its count as 1. Subsequently, a second thread seeking to acquire an exclusive lock on the shared resource could read the first thread's count at 1 as well. The first thread would increment its count to 2 and write the count of 2 with the appearance that it is achieving a shared acquisition of the shared resource. However, the second thread is decrementing the count, 1, which it read from the first thread, and is writing a count of zero for the first thread. Hence, due to such a race condition, it appears to the second thread that it has exclusively acquired the shared resource, and it appears to the first thread that it has acquired a shared lock on the shared resource, when in reality only the first thread to have completed its necessary micro-ops will have actually acquired the shared resource.

Thus, in shared and exclusive lock mechanisms, race conditions and requirements to use atomic instructions introduce significant drawbacks. Furthermore, such drawbacks are also prevalent even when using single instruction increment and decrement methods.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A technology for exclusively acquiring a shared resource is disclosed. In one approach, a determination is made as to whether a shared resource is available to be exclusively acquired by an initial thread. Other threads are prevented from performing partial execution of operations, during operations to exclusively acquire the shared resource by the initial thread. The preventing of partial execution of operations by other threads is initiated by the exclusively acquiring initial thread. Operations are then performed to exclusively acquire the shared resource by the initial thread.

### DESCRIPTION OF THE DRAWINGS

The accompanying drawings, which are incorporated in and form a part of this specification, illustrate embodiments of the invention and, together with the description, serve to explain principles discussed below:

FIG. 1 is a diagram of an exemplary computer system used in accordance with embodiments of the present shared resource acquisition technology.

FIG. 2 is a flow chart of operations performed in accordance with one embodiment of the present shared resource acquisition technology.

FIG. 3 is a flow chart of operations performed in accordance with one embodiment of the present shared resource acquisition technology.

FIG. 4 shows a table of thread counts for exemplary threads at differing times during execution of the present shared resource acquisition technology.

FIG. 5 is a diagram of one embodiment of the present shared resource acquisition system.

FIG. 6 is a diagram of another embodiment of the present shared resource acquisition system that includes a shared resource acquisition module.

The drawings referred to in this description should be understood as not being drawn to scale except if specifically noted.

### DETAILED DESCRIPTION

Reference will now be made in detail to embodiments of the present technology for shared resource acquisition, examples of which are illustrated in the accompanying drawings. While the technology for shared resource acquisition will be described in conjunction with various embodiments, it will be understood that they are not intended to limit the present technology for shared resource acquisition to these embodiments. On the contrary, the present technology for shared resource acquisition is intended to cover alternatives, modifications and equivalents, which may be included within the spirit and scope the various embodiments as defined by the appended claims. Furthermore, in the following detailed description, numerous specific details are set forth in order to provide a thorough understanding of the present technology for shared resource acquisition. However, the present technology for shared resource acquisition may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “determining”, “preventing”, “performing”, “issuing”, “suspending” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology for shared resource acquisition is also well suited to the use of other computer systems such as, for example, optical and mechanical computers. Additionally, it should be understood that in embodiments of the present technology for shared resource acquisition, one or more of the steps can be performed manually.

### Example Computer System Environment

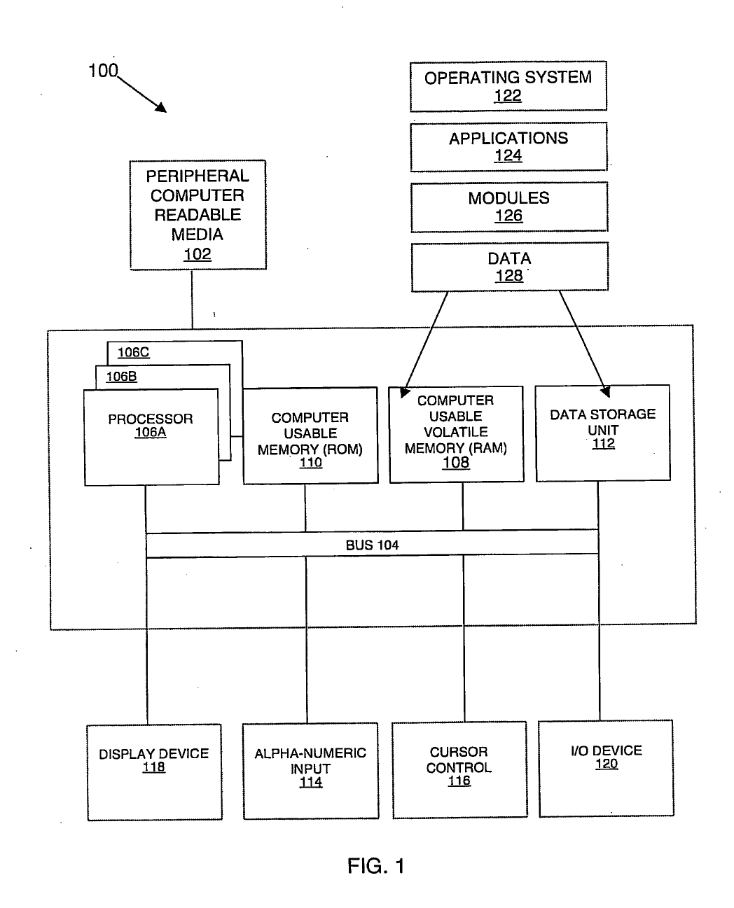

With reference now to FIG. 1, portions of the shared resource acquisition technology are composed of computer-readable and computer-executable instructions that reside, for example, in computer-usable media of a computer system. That is, FIG. 1 illustrates one example of a type of computer that can be used to implement embodiments, which are discussed below, of the present shared resource acquisition technology. FIG. 1 illustrates an exemplary computer system 100 used in accordance with embodiments of the present technology for shared resource acquisition. It is appreciated that system 100 of FIG. 1 is exemplary only and that the present technology for shared resource acquisition can operate on or within a number of different computer systems including general purpose networked computer systems, embedded computer systems, routers, switches, server devices, client devices, various intermediate devices/nodes, stand alone computer systems, and the like. As shown in FIG. 1, computer system 100 of FIG. 1 is well adapted to having peripheral computer readable media 102 such as, for example, a floppy disk, a compact disc, and the like coupled thereto.

System 100 of FIG. 1 includes an address/data bus 104 for communicating information, and a processor 106A coupled to bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 106B, and 106C may be any of various types of microprocessors. System 100 also includes data storage features such as a computer usable volatile memory 108, e.g. random access memory (RAM), coupled to bus 104 for storing information and instructions for processors 106A, 106B, and 106C. System 100 also includes computer usable non-volatile memory 110, e.g. read only memory (ROM), coupled to bus 104 for storing static information and instructions for processors 106A, 106B, and 106C. Also present in system 100 is a data storage unit 112 (e.g., a magnetic or optical disk and disk drive) coupled to bus 104 for storing information and instructions. System 100 also includes an optional alphanumeric input device 114 including alphanumeric and function keys coupled to bus 104 for communicating information and command selections to processor 106A or processors 106A, 106B, and 106C. System 100 also includes an optional cursor control device 116 coupled to bus 104 for communicating user input information and command selections to processor 106A or processors 106A, 106B, and 106C. System 100 of the present embodiment also includes an optional display device 118 coupled to bus 104 for displaying information.

Referring still to FIG. 1, optional display device 118 of FIG. 1, may be a liquid crystal device, cathode ray tube, plasma display device or other display device suitable for creating graphic images and alphanumeric characters recognizable to a user. Optional cursor control device 116 allows the computer user to dynamically signal the movement of a visible symbol (cursor) on a display screen of display device 118. Many implementations of cursor control device 116 are known in the art including a trackball, mouse, touch pad, joystick or special keys on alpha-numeric input device 114 capable of signaling movement of a given direction or manner of displacement. Alternatively, it will be appreciated that a cursor can be directed and/or activated via input from alpha-numeric input device 114 using special keys and key sequence commands. System 100 is also well suited to having a cursor directed by other means such as, for example, voice commands. System 100 also includes an I/O device 120 for coupling system 100 with external entities. For example, in one embodiment, I/O device 120 is a modem for enabling wired or wireless communications between system 100 and an external network such as, but not limited to, the Internet. A more detailed discussion of the present shared resource acquisition technology is found below.

Referring still to FIG. 1, various other components are depicted for system 100. Specifically, when present, an operating system 122, applications 124, modules 126, and data 128 are shown as typically residing in one or some combination of computer usable volatile memory 108, e.g. random access memory (RAM), and data storage unit 112. In one embodiment of the present shared resource acquisition technology, the shared resource is, for example, a common memory location within RAM 108. The common memory location, in one embodiment, contains data that is to be accessed by multiple threads.

### General Description of the Shared Resource Acquisition Technology

As an overview, in one embodiment, the present shared resource acquisition technology is directed towards a method for exclusively acquiring a shared resource in a manner that does not impose a burden on corresponding shared acquisitions. In one embodiment, the present shared resource acquisition technology is utilized in an environment where shared acquisitions will occur frequently, and exclusive acquisitions will occur less frequently. Hence, the present shared resource acquisition technology can have an asymmetric distribution of expense between shared acquisitions and exclusive acquisitions. More specifically, in embodiments of the present shared resource acquisition technology, exclusive acquisitions have more expense associated therewith than is associated with corresponding shared acquisitions. In fact, in embodiments of the present shared resource acquisition technology, the manner in which exclusive acquisitions are performed imposes no additional burden on corresponding shared acquisitions of shared resources. Also, as will be described below in detail, exclusive acquisitions performed in accordance with the present shared resource acquisition technology, do not require altering of existing corresponding shared acquire methods. Moreover, the present shared resource acquisition technology is operable in conjunction with shared acquires performed according to existing shared acquisition methods, but wherein the shared acquires employ less expensive, i.e. non-atomic, instructions. Also, for purpose of the present application, it should be understood that the term “locking” of a resource refers to a form of acquiring of the resource.

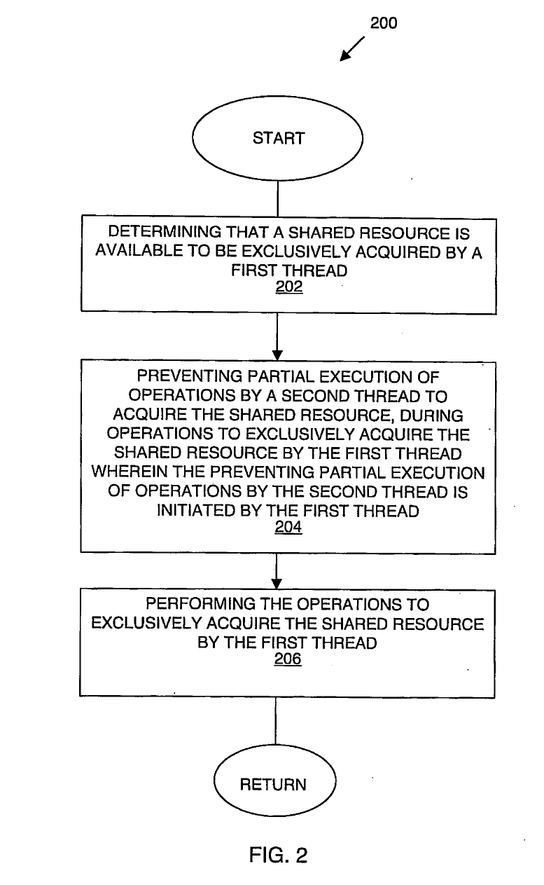

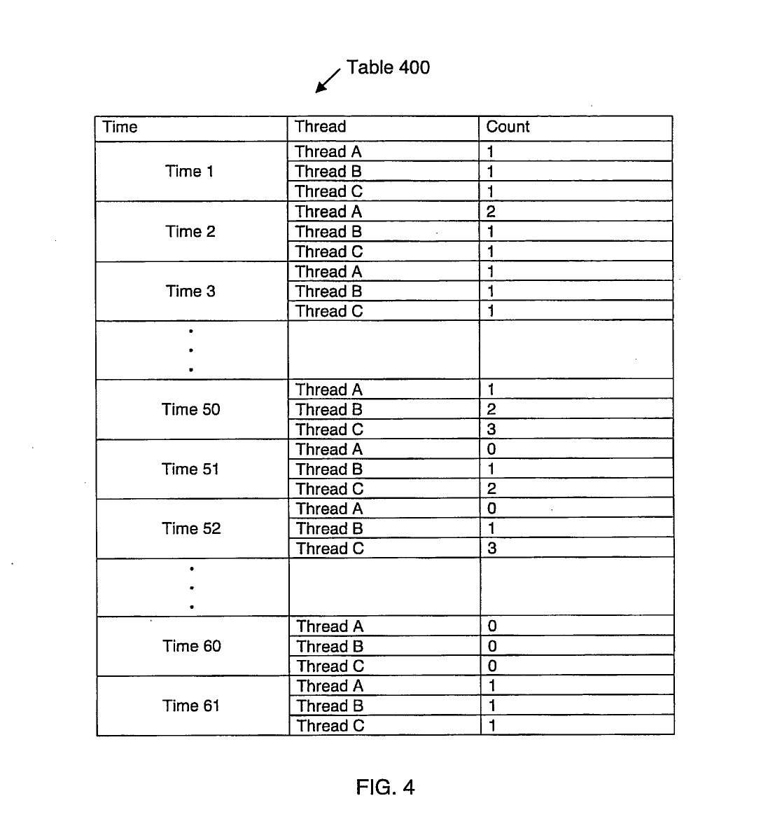

With reference next to FIG. 2, a flow chart 200 illustrates exemplary steps used by the various embodiments of present shared resource acquisition technology. Flow chart 200 includes processes that, in one embodiment, are carried out by a processor under the control of computer-readable and computer-executable instructions. The computer-readable and computer-executable instructions reside, for example, in data storage features such as computer usable volatile memory 108, computer usable non-volatile memory 110, and/or data storage unit 112 of FIG. 1. The computer-readable and computer-executable instructions are used to control or operate in conjunction with, for example, processor 106A and/or processors 106A, 106B, and 106C of FIG. 1. Furthermore, flow chart 200 will be described in conjunction with Table 400 of FIG. 4 to more clearly describe aspects of the present shared resource acquisition technology. Table 400 of FIG. 4 is a table of thread counts for exemplary threads at differing times during execution of the present shared resource acquisition technology. Moreover, the significance of the thread counts at the different times will be discussed in turn below in conjunction with the description of FIG. 2.

Referring to flow chart 200 of FIG. 2, at step 202, the present shared resource acquisition method initially determines that a shared resource is available to be exclusively acquired by a first thread. For example, Thread A determines that a memory location within data storage unit 112 is a resource that is shared between Thread A, Thread B, and Thread C. Thread A is running on processor 106A, while Thread B and Thread C are both running (at different times) on processor 106B. Although a common memory location within data storage unit 112 is used as the shared resource in the above example, it should be understood that such a shared resource is used for purposes of illustration. That is, the present shared resource acquisition technology is well suited to use with various types of shared resources that may or may not be located in various other locations. Additional types of resources that can be shared include, but are not limited to, cache locations, peripheral components, and the like.

For purposes of illustration, the following discussion will first describe shared acquisitions of the shared resource. In Table 400, at Time 1, each of the separate count variables for each thread, Thread A, Thread B, and Thread C, in the process is set at 1. When a thread wishes to acquire a shared lock, that is, when a thread wishes to perform a shared acquisition of the shared resource, the acquiring thread increments its count by 1. Hence, at Time 2, Thread A has performed a shared acquire of the shared resource, for example, the common memory location within data storage unit 112 of FIG. 1. As a result, at Time 2, Thread A has a count of 2. In order to release the shared lock, the acquiring thread must then decrement its count by 1. Thus, at Time 3, wherein Thread A has released its shared lock on the shared resource, Thread A has decremented its count from 2 back to 1. From the above example, it can be seen that multiple recursive shared acquires (i.e., a thread repeatedly invoking itself) can cause a thread's count to increment to a value greater than 2 until the thread releases all of its shared locks and ultimately decrements its count back to 1.

Referring again to step 202, at Time 50, Thread A has determined that a shared resource, for example, the common memory location within data storage unit 112, is available to be exclusively acquired. As shown in Table 400 at Time 50, Thread A has a count of 1, Thread B has a count of 2, and Thread C has a count of 3. As Thread A wishes to exclusively acquire the available shared resource, the present shared resource acquisition method proceeds to step 204 of flow chart 200.

At step 204 of FIG. 2, Thread A now prevents partial execution of operations by Thread B and Thread C. More specifically, in one embodiment, Thread A prevents partial execution of operations by Thread B and Thread C to acquire the shared resource during operations by Thread A to exclusively acquire the available shared resource. To prevent partial execution of operations by Thread B and Thread C to acquire the shared resource, Thread A issues an interrupt to the processor running Thread B and Thread C. More specifically, in one embodiment of the present shared resource acquisition method, the issuance of the interrupt causes operations on Thread B and Thread C to acquire the shared resource to be either fully completed or prevented from being started prior to performing operations to exclusively acquire the shared resource by Thread A. The issuance of the interrupt at step 204 of FIG. 2 guarantees that Thread B and Thread C are interrupted in whatever they are doing, and are suspended until released. Advantageously, in the present shared resource acquisition method, once a thread is interrupted, the processor unwinds the thread's execution in such a way that every instruction in the code stream is either completed, or not yet started. Also, in the present shared resource acquisition technology, the prevention of partial execution of operations by the second thread is initiated by the first thread. Hence, in the present shared resource acquisition technology, it is solely the exclusively acquiring thread that prevents the partial execution of operations. As a result, the present shared resource acquisition technology does not impose any additional burden on shared acquirers.

In the present shared resource acquisition method, it is usually only necessary to issue the interrupt to the processor or processors running Thread B or Thread C (although a universal or cross-processor interrupt might also be employed). Thus, in this example, it is only necessary to issue the interrupt to processor 106B of FIG. 1. Although a single processor is described as running both Thread B and Thread C in the following examples, it should be understood that the use of a single processor is described for purposes of illustration. It should further be noted that the present shared resource acquisition technology is well suited to use in environments in which various threads are running on different processors. Also in the present shared resource acquisition system and method, for threads that are not running, it is guaranteed that prior to preemption, an interrupt occurs and that no instructions remain partially executed. It should further be noted, that it is a default property of an interrupt to cause an interrupted thread to behave in the manner described in the present application.

Referring still to step 204 of FIG. 2, in one embodiment of the present shared resource acquisition method, the interrupt is an Inter-Processor Interrupt (IPI). In other embodiments, the present method employs various other interrupting mechanisms. For example, in one embodiment, the present shared resource acquisition method queues an asynchronous procedure call (APC) to each thread in the process, and decrements the count of the threads inside the APC. In another embodiment, Thread A, Thread B, and Thread C operate on a shared processor, for example, processor 106A of FIG. 1. In such a shared processor environment, the interrupt issued at step 204 of FIG. 2 causes operations on Thread B and Thread C to be either fully completed or prevented from being started prior to removing Thread B and/or Thread C from processor 106A and prior to performing operations to exclusively acquire the shared resource by Thread A.

Thus, in one embodiment, the interrupt issued at step 204 of FIG. 2 advantageously requires that the operations or micro-operations of Thread B and Thread C to acquire the shared resource either be fully completed or prevented from being started prior to Thread A attempting to exclusively acquire the shared resource. Such an approach beneficially avoids deleterious race conditions. Issuing an interrupt as described at step 204 prevents partial execution of operations or micro-ops by other threads to acquire the shared resource during operations to exclusively acquire the shared resource by a first thread, the present shared resource acquisition method eliminates the possibility of the above-described race conditions. More specifically, in the present shared resource acquisition method, at step 204 of FIG. 2, all of the micro-ops of single-instruction increment or decrement operations are either completed, or not yet started, when the thread is suspended as a result of having an interrupt issued to its processor.

Similarly, in an embodiment in which an APC is made, the thread's regular code is interrupted to take the APC. As a result, the present shared resource acquisition method again guarantees that operations or micro-ops inside the single-instruction increment or decrement will either be completed or not started prior to performing the exclusive acquire of the shared resource. Thus, in such an embodiment of the present shared resource acquisition method, the race conditions described above are again avoided.

Additionally, by issuing the interrupt as described at step 204 of FIG. 2, the present shared resource acquisition method is able to avoid race conditions during exclusive acquires without requiring the use of atomic operations. It should be understood, that an “atomic” operation is an operation that cannot be interrupted once it has started. It is well known that atomic operations are very expensive relative to non-atomic operations. Hence, exclusive acquisitions performed in accordance with the present shared resource acquisition method do not require imposing an additional burden on corresponding shared acquisitions of any shared resources. Moreover, by issuing the interrupt prior to exclusive acquires as described at step 204 of FIG. 2, the present shared resource acquisition method enables the use of single-instruction increment and decrement operations for corresponding shared acquires of the shared resources. As a result, the present shared resource acquisition method may minimize or avoid alteration of existing corresponding shared acquire methods.

Referring now to step 206 of FIG. 2, the present shared resource acquisition method performs operations to exclusively acquire the shared resource by Thread A. As shown in Table 400, at Time 50, Thread A begins performing the operations necessary to exclusively acquire the shared resource. At time 50, numerous shared acquisitions have been made by a thread (e.g. Thread C). Therefore, Thread C has count of 3, while Thread B has a count of 2 and Thread A has a count of 1. In this embodiment of the present shared resource acquisition technology, Thread A then decrements the counts of Thread B and Thread C by 1. Such a result is shown in Table 400 at Time 51 where Thread A has decremented its count from 1 to zero, and has also decremented Thread B from 2 to 1 and Thread C from 3 to 2. Again, if numerous shared acquisitions have been made by a thread (e.g. Thread C), it is possible that the thread will have a count of greater than 2. In such a case, the thread must release all of its shared acquisitions in order to return to a count of one and then ultimately to zero. Hence, Thread A then waits until Thread B and Thread C both have a count of zero, which indicates that Thread B and Thread C have released their shared acquires. During this waiting period, it is possible that the count of Thread B and/or the count of Thread C will actually increment and correspondingly decrement several times before ultimately decrementing to zero. That is, in the present shared resource acquisition technology, it is possible that Thread B or Thread C will actually increase their count before ultimately decrementing to a count of zero.

Once Thread B and Thread C have a count of zero, Thread A has acquired the shared resource exclusively. In Table 400, at Time 60, Thread A, Thread B, and Thread C have all decremented to zero, and Thread A has now exclusively acquired the shared resource. During the time that Thread A has the shared resource exclusively acquired, Thread B and Thread C are unable to perform a shared acquisition of the shared resource. Thus, in the present shared resource acquisition method, exclusive acquires use an interrupt mechanism to ensure that partial execution of operations by other threads are prevented during operations to exclusively acquire said shared resource by the first thread. However, in most implementations no expense should be imparted to corresponding shared acquires of the shared resource. That is, in the present shared resource acquisition method, expense associated with acquires is asymmetrically shifted to the exclusive acquires. Therefore, the present shared acquisition technology is well suited to use in environments where shared acquires must be fast or inexpensive. Such an environment exists, for example, when shared acquires occur substantially more frequently than exclusive acquires.

Referring still to Table 400, at Time 61, Thread A has released its exclusive lock on the shared resource and incremented its count and the count of Thread B and Thread C to one. In the present shared resource acquisition technology, Thread B and Thread C are then able to attempt to acquire a lock (either shared or exclusive) on the shared resource.

Although three threads, Thread A, Thread B, and Thread C, were used in the above examples, it should be understood that such a number of threads is used for purposes of illustration only. It should further be noted that the present shared resource acquisition technology is well suited to use with various other numbers of threads. As mentioned above, although a common memory location within data storage unit 112 was used as the shared resource, it should be understood that such a shared resource is used for purposes of illustration. That is, the present shared resource acquisition technology is well suited to use with various types of shared resources that may or may not be located in various other locations.

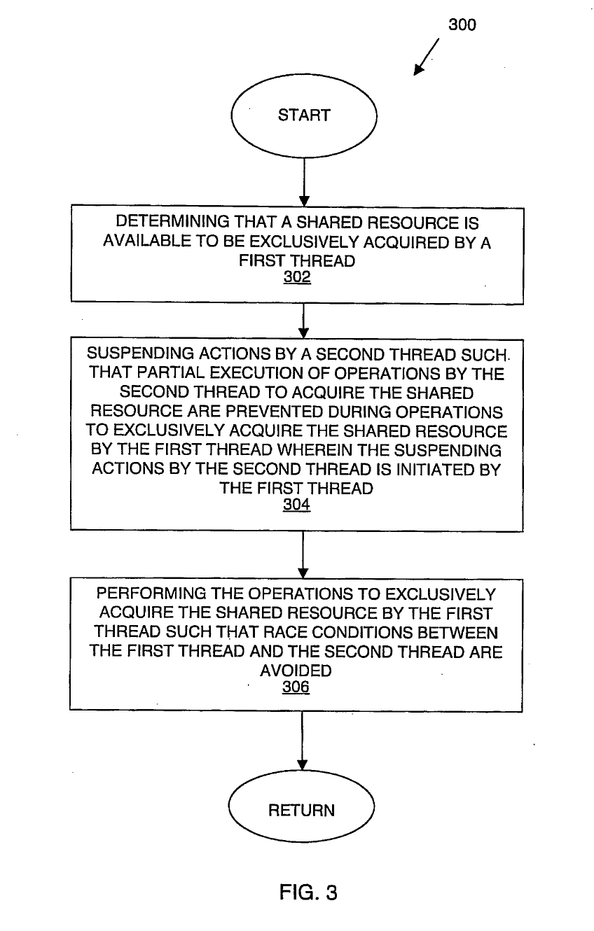

Referring now to FIG. 3, a flow chart 300 of operations performed in accordance with another embodiment of the present shared resource acquisition technology is shown. The operations recited in Flow chart 300 function in the same manner as the operations recited in flow chart 200, but the description of the processes varies to clearly point advantages of the present shared resource acquisition method. For example, step 302 of FIG. 3 is identical to step 202 of FIG. 2.

At step 304, flow chart 300 describes suspending actions by a second thread such that partial execution of operations by said second thread are prevented during operations to exclusively acquire the shared resource by the first thread. This description is intended to explicitly point out that the present shared resource acquisition method prevents partial execution of operations by other threads during operations to exclusively acquire the shared resource by the first thread. Moreover, the present shared resource acquisition method prevents not just operations but also the micro-ops which make up the operations. A detailed discussion of such functionality is given above in the description of step 204 of FIG. 2. Also, in the present shared resource acquisition technology, the suspension of actions by the second thread is initiated by the first thread. Hence, in one embodiment of the present shared resource acquisition technology, it is solely the exclusively acquiring thread that causes the suspension of actions to occur. As a result, the present shared resource acquisition technology does not impose any additional burden on shared acquirers.

Similarly, at step 306, the method of flow chart 300 performs operations to exclusively acquire the shared resource by the first thread such that race conditions between the first thread and the second thread are avoided. By suspending actions as described at step 204 of FIG. 2, the present shared resource acquisition method prevents partial execution of operations or micro-ops by other threads during operations to exclusively acquire the shared resource by a first thread. And, as a result, the present shared resource acquisition method eliminates the possibility of the above-described race conditions. Additionally, as was described in detail above, it should be understood that exclusive acquisitions performed in accordance with the present shared resource acquisition method, as described in flow chart 200 and flow chart 300, do not require imposing an additional burden on corresponding shared acquisitions of any shared resources. Also, the shared resource acquisition method of flow chart 200 and flow chart 300 does not require altering of existing corresponding shared acquire methods, and does not require utilizing atomic operations during corresponding shared acquisitions of any shared resources.

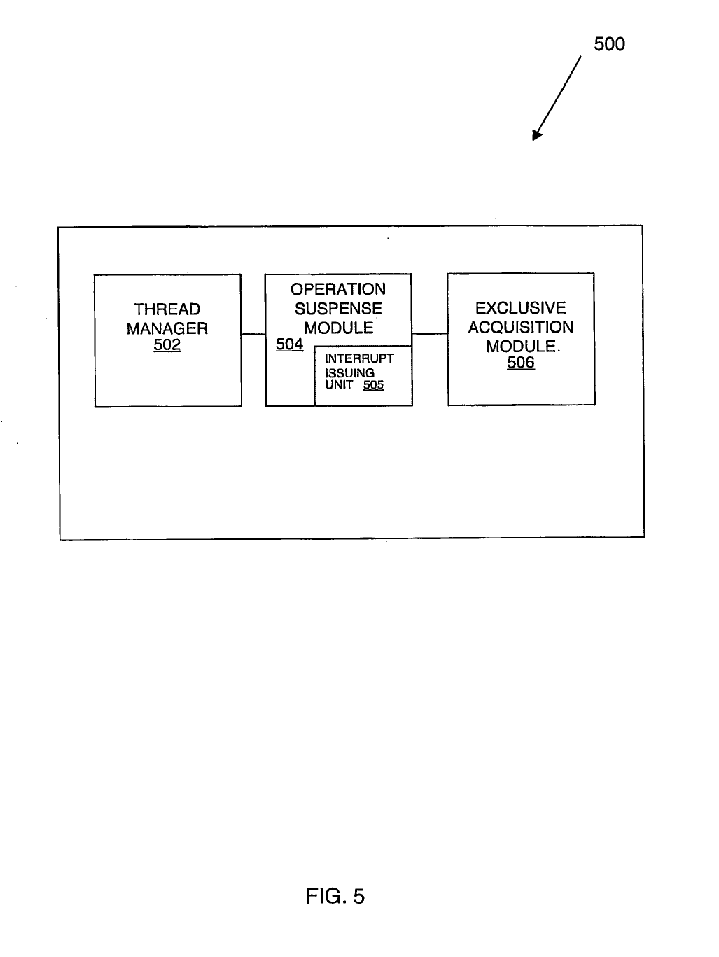

Referring now to FIG. 5, a diagram of one embodiment of a present shared resource acquisition system 500 is shown. As schematically depicted in FIG. 5, shared resource acquisition system 500 includes a thread manager 502, an operation suspension module 504, and an exclusive acquisition module 506. Although shared resource acquisition system 500 is shown as an integrated and contiguous system in FIG. 5, shared resource acquisition system 500 is also well suited to at being least partially or even entirely distributed among various remotely located components. Also, shared resource acquisition system 500 is well suited to being implemented as hardware, software, firmware, or some combination thereof.

In the present embodiment, thread manager 502 is configured to determine when a shared resource is available to be exclusively acquired by a first thread. That is, thread manager 502 is configured to perform the operations described above in conjunction with step 202 of FIG. 2 and step 302 of FIG. 3.

Shared resource acquisition system 500 also includes an operation suspension module 504 that is shown coupled to thread manager 502. Operation suspension module 504 performs the task of preventing partial execution of operations by a second thread, during operations to exclusively acquire a shared resource by a first thread. Hence, operation suspension module 504 performs the tasks described above in detail in conjunction with the description of step 204 and step 304 of FIG. 2 and FIG. 3, respectively. Furthermore, in one embodiment of the present shared resource acquisition system 500, operation suspension module 504 further includes an interrupt issuing unit 505. Interrupt issuing unit 505 is configured to issue an interrupt to a second thread when the first thread wishes to acquire the shared resource exclusively. In one embodiment, the interrupt issued by interrupt issuing unit 505 causes operations on the second thread to be either fully completed or prevented from being started prior to performing operations to exclusively acquire the shared resource by the first thread. Again, such operations are described above in detail in conjunction with the description of step 204 and step 304 of FIG. 2 and FIG. 3, respectively.

In one embodiment of the present shared resource acquisition system 500, interrupt issuing unit 505 is configured to issue an Inter-processor Interrupt (IPI) to the second thread. Also, in one embodiment of the present shared resource acquisition system 500, the first thread and the second thread operate on a shared processor. In one such embodiment, operation suspension module 504 causes operations on the second thread to be either fully completed or prevented from being started prior to removing the second thread from the processor shared with the first thread. Furthermore, shared resource system 500 utilizes operation suspension module 504 to perform the aforementioned task prior to performing operations to exclusively acquire the shared resource by the first thread.

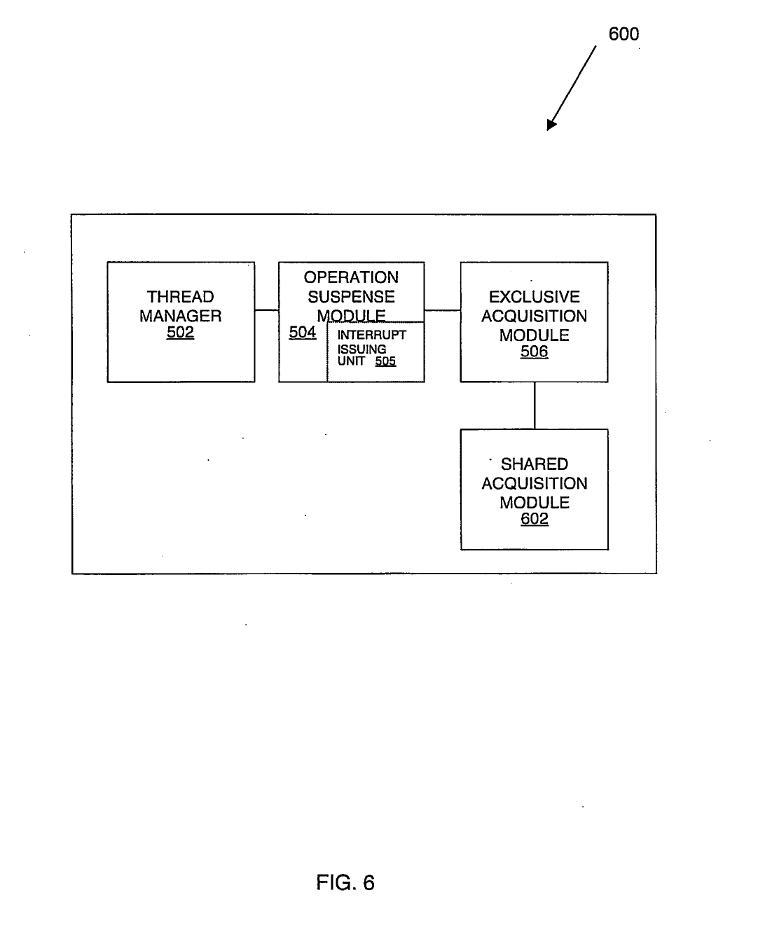

Referring again to FIG. 5, shared resource acquisition system 500 further includes an exclusive acquisition module 506 that is shown coupled to operation suspension module 504. Exclusive acquisition module 506 is configured to perform the operations for acquiring the shared resource by the first thread. A detailed description of such operations is found above at the discussion of step 206 of FIG. 2 and step 306 of FIG. 3. In the present shared resource acquisition technology, exclusive acquisition module 506 is further configured to initiate action by operation suspension module 504. Hence, shared resource acquisition system 500 should not impose any additional burden on shared acquires by, for example, shared acquisition module 602 of FIG. 6.

Referring next to FIG. 6, a diagram of another embodiment of the present shared resource acquisition system 600 is shown. As schematically depicted in FIG. 6, shared resource acquisition system 600 includes a thread manager 502, an operation suspension module 504, an exclusive acquisition module 506, and a shared acquisition module 602. The operation of thread manager 502, operation suspension module 504 (including interrupt issuing unit 505), and exclusive acquisition module 506 was described in detail above in the discussion of FIG. 5. For purposes of brevity and clarity, the discussion of these components of shared resource acquisition module 602 is not repeated here. Although shared resource acquisition system 600 is shown as an integrated and contiguous system in FIG. 6, shared resource acquisition system 600 is also well suited to at being least partially or even entirely distributed among various remotely located components. Also, shared resource acquisition system 600 is well suited to being implemented as hardware, software, firmware, or some combination thereof.

In shared resource acquisition system 600, shared acquisition module 602 is shown coupled to exclusive acquisition module 506. Shared acquisition module 602 is configured to perform operations to non-exclusively acquire the shared resource. That is, shared acquisition module 602 performs the various above-described operations to achieve a shared acquisition of the shared resource.

Beneficially, as described above in conjunction with the description of step 204 and step 304 of FIG. 2 and FIG. 3, respectively, in shared resource acquisition system 600, exclusive acquisition module 506 is operable without imposing any additional burden on shared acquisition module 602. Also, shared acquisition module 602 is operable without require alterations to existing shared acquire methods.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for exclusively acquiring a shared resource, said computer-implemented method comprising:
determining that said shared resource is available to be exclusively acquired by a first thread;
preventing partial execution of operations by a second thread to acquire said shared resource, during operations to exclusively acquire said shared resource by said first thread, wherein said preventing partial execution of operations by said second thread is initiated by said first thread; and
performing said operations to exclusively acquire said shared resource by said first thread.

2. The computer-implemented method as recited in claim 1 wherein said preventing partial execution of operations by a second thread comprises:
issuing an interrupt to a processor on which said second thread is running wherein said interrupt causes operations of said second thread to be either fully completed or prevented from being started prior to said performing said operations to exclusively acquire said shared resource by said first thread.

3. The computer-implemented method as recited in claim 2 wherein issuing an interrupt to a processor on which said second thread is running comprises:
issuing an Inter-processor Interrupt (IPI) to said processor on which said second thread is running.

4. The computer-implemented method as recited in claim 1 wherein said preventing partial execution of operations by a second thread comprises:
on a processor shared between said first thread and said second thread, causing operations on said second thread to be either fully completed or prevented from being started prior to removing said second thread from said processor and prior to performing said operations to exclusively acquire said shared resource by said first thread.

5. The computer-implemented method as recited in claim 1 wherein said computer-implemented method does not require the use of atomic instructions on corresponding shared acquisitions of any shared resources.

6. The computer-implemented method as recited in claim 1 wherein said computer-implemented method does not require altering of existing corresponding shared acquire methods.

7. A system for acquiring a shared resource, said system comprising:
a thread manager, said thread manager configured to determine when a shared resource is available to be exclusively acquired by a first thread;
an operation suspension module coupled to said thread manager, said operation suspension module preventing partial execution of operations by a second thread to acquire said shared resource, during operations to exclusively acquire said shared resource by said first thread; and
an exclusive acquisition module coupled to said operation suspension module, said exclusive acquisition module configured to perform said operations to exclusively acquire said shared resource by said first thread, said exclusive acquisition module further configured to initiate action by said operation suspension module.

8. The system of claim 7 wherein said operation suspension module comprises:
an interrupt issuing unit configured to issue an interrupt to a processor on which said second thread is running wherein said interrupt causes operations on said second thread to be either fully completed or prevented from being started prior to performing said operations to exclusively acquire said shared resource by said first thread.

9. The system of claim 8 wherein said interrupt issuing unit is configured to issue an Inter-processor Interrupt (IPI) to said processor on which said second thread is running.

10. The system of claim 7 wherein said operation suspension module is configured to cause operations on said second thread to be either fully completed or prevented from being started prior to removing said second thread from a processor shared with said first thread, and prior to performing said operations to exclusively acquire said shared resource by said first thread.

11. The system of claim 7 further comprising:
a shared acquisition module coupled with said exclusive acquisition module, said shared acquisition module configured to perform said operations to non-exclusively acquire said shared resource.

12. The system of claim 11 wherein said exclusive acquisition module is operable without the shared acquisition module using atomic instructions.

13. The system of claim 11 wherein said shared acquisition module is operable without requiring altering of existing shared acquire methods.

14. Instructions on a computer-usable medium wherein the instructions when executed cause a computer system to perform a shared resource acquisition method, said method comprising:
determining that said shared resource is available to be exclusively acquired by a first thread;
suspending actions by a second thread such that partial execution of operations by said second thread to acquire said shared resource are prevented during operations to exclusively acquire said shared resource by said first thread, wherein said suspending actions by said second thread is initiated by said first thread; and
performing said operations to exclusively acquire said shared resource by said first thread such that race conditions between said first thread and said second thread are avoided.

15. The instructions of claim 14 wherein said instructions which when executed cause said computer system to suspend actions by a second thread further comprise instructions which cause said computer system to:
issue an interrupt to a processor on which said second thread is running wherein said interrupt causes operations on said second thread to be either fully completed or prevented from being started prior to said performing said operations to exclusively acquire said shared resource by said first thread.

16. The instructions of claim 15 wherein said instructions which when executed cause said computer system to issue said interrupt to said processor in which said second thread is running further comprise instructions which cause said computer system to:
issue an Inter-processor Interrupt (IPI) to said processor on which said second thread is running.

17. The instructions of claim 14 wherein said instructions which when executed cause said computer system to suspend actions by a second thread further comprise instructions which cause said computer system to:
on a processor shared between said first thread and said second thread, cause operations on said second thread to be either fully completed or prevented from being started prior to removing said second thread from said processor and prior to performing said operations to exclusively acquire said shared resource by said first thread.

18. The instructions of claim 14 wherein said shared resource acquisition method performed by said computer system does not require imposing an additional burden on corresponding shared acquisitions of any shared resources.

19. The instructions of claim 14 wherein said shared resource acquisition method performed by said computer system does not require altering of existing corresponding shared acquire methods.

20. The instructions of claim 14 wherein said shared resource acquisition method performed by said computer system does not require utilizing atomic operations during corresponding shared acquisitions of any shared resources.
